(19) United States
(12) Patent Application Publication
(10) Pub. No.: US 2026/0238488 A1
(43) Pub. Date: Aug. 13, 2026

(54) PROTECTION OF TNGF ADDRESS ALLOCATION

(71) Applicant: TELEFONAKTIEBOLAGET LM ERICSSON (PUBL), STOCKHOLM (SE)

(72) Inventors: Vesa Lehtovirta, Espoo (FI); Helena Vahidi Mazinani, Lund (SE)

(21) Appl. No.: 19/156,275

(22) PCT Filed: Feb. 13, 2024
(86) PCT No.: PCT/IB2024/051330

§ 371 Date: Aug. 13, 2025

Related U.S. Application Data
(60) Provisional application No. 63/445,223, filed on Feb. 13, 2023.

(51) Int. Cl. H04L 9/32

(52) U.S. Cl. CPC H04L 9/3242

(57) ABSTRACT

A user equipment (UE) performs a method for determining an address of a first network node Trusted Non-3GPP Gateway Function. The UE receives from the first network node, a protected address of the first network node. The UE unprotects the protected address of the first network node, verifies an integrity of the address of the first network node based on the key associated with the first network node or decrypts the protected address of the first network node, and it initiates a security protocol with the first network node based on the address of the first network node.

### TECHNICAL FIELD

Certain embodiments of the disclosed subject matter relate to mobile networks, non-third generation partnership project (N3GPP) access networks, security, and/or access authentication.

### BACKGROUND

3GPP Technical Specification (TS) 33.501, clause 7A.2.1 specifies Authentication for trusted non-3GPP access as follows. Note that reference numbers in the text below, e.g., “RFC 7296 [25]” are from the specification and do not match with the references of the present disclosure.

This clause specifies how a User Equipment (UE) is authenticated to Fifth Generation (5G) network via a trusted non-3GPP access network.

FIGS. 1A and 1B correspond to FIG. 7A.2.1-1 from TS 33.501: Registration/Authentication and Protocol Data Unit (PDU) Session establishment for trusted non-3GPP access. This is based on the specified procedure in TS 23.502 clause 4.12a.2.2 “Registration procedure for trusted non-3GPP access”. The authentication procedure is similar to the authentication procedure for trusted non-3GPP access defined in clause 7.2.1 with few differences, which are mentioned below. It is to be appreciated that the current 3GPP specification contains an error, and that the Trusted Non-3GPP Gateway Function (TNGF) address is show in the figure as being shared at both steps 9b and 10b and that step 13 described below corresponds to step 9b in FIG. 1A. This is an error and is depicted with strikethroughs.
0. The UE selects a PLMN and a TNAN for connecting to this PLMN by using the Trusted Non-3GPP Access Network selection procedure specified in TS 23.501 [2] clause 6.3.12. During this procedure, the UE discovers the PLMNs with which the TNAN supports trusted connectivity (e.g. “5G connectivity”).
1. A layer-2 connection is established between the UE and the TNAP. In case of IEEE 802.11 [80], this step corresponds to an 802.11 [80] Association. In case of PPP, this step corresponds to a PPP LCP negotiation. In other types of non-3GPP access (e.g. Ethernet), this step may not be required.
2-3. An EAP authentication procedure is initiated. EAP messages shall be encapsulated into layer-2 packets, e.g. into IEEE 802.3/802.1x packets, into IEEE 802.11/802.1x packets, into PPP packets, etc. The UE provides a NAI that triggers the TNAP to send an AAA request to a TNGF. Between the TNAP and TNGF the EAP packets are encapsulated into AAA messages.
4-10. An EAP-5G procedure is executed as specified in clause 7.2.1 with the following modifications:
   The EAP-5G packets shall not be encapsulated into IKEv2 packets. The UE shall also include a UE Id in the AN parameters, e.g. a 5G-GUTI if available from a prior registration to the same PLMN.
   A K_{TNGF} as specified in clause Annex A.9 (equivalent to K_{N3IWF}) is created in the UE and in the AMF after the successful authentication. The K_{TNGF} is transferred from the AMF to TNGF in step 10a (within the N2 Initial Context Setup Request).
   The TNAP is a trusted entity. The TNGF shall generate the K_{TNAP} as specified in Annex A.22 and transfers it from TNGF to TNAP in step 10b (within an AAA message).
   After receiving the TNGF key from AMF in step 10a, the TNGF shall send to UE an EAP-Request/5G-Notification packet containing the “TNGF Contact Info”, which includes the IP address of TNGF. After receiving an EAP-Response/5G-Notification packet from the UE, the TNGF shall send message 10b containing the EAP-Success packet.
11. The common TNAP key is used by the UE and TNAP to derive security keys according to the applied non-3GPP technology and to establish a security association to protect all subsequent traffic. In case of IEEE 802.11 [80], the K_{TNAP} is the Pairwise Master Key (PMK) and a 4-way handshake is executed (see IEEE 802.11 [80]) which establishes a security context between the WLAN AP and the UE that is used to protect unicast and multicast traffic over the air. All messages between UE and TNAP are encrypted and integrity protected from this step onwards.
NOTE 1: whether step 11 is performed out of the scope of this document. The current procedure assumes the encryption protection over Layer-2 between UE and TNAP is to be enabled.
12. The UE receives IP configuration from the TNAN, e.g. with DHCP.
13. The UE shall initiate an IKE_INIT exchange with the TNGF. The UE has received the IP address of TNGF during the EAP-5G signaling in step 10b, subsequently, the UE shall initiate an IKE_AUTH exchange and shall include the same UE Id (i.e. SUCI or 5G-GUTI) as in the UE Id provided in step 5. The common K_{TIPSe} is used for mutual authentication. The key K_{TIPSec} is derived as specified in Annex A.22.NULL encryption is negotiated as specified in RFC 2410 [81]. After step 13c, an IPsec SA is established between the UE and TNGF (i.e. a NWt connection) and it is used to transfer all subsequent NAS messages. This IPsec SA does not apply encryption but only apply integrity protection.
14. After the NWtp connection is successfully established, the TNGF responds to AMF with an N2 Initial Context Setup Response message.
15. Finally, the NAS Registration Accept message is sent by the AMF and is forwarded to UE via the established NWt connection.
16-18. The UE initiates a PDU session establishment. This is carried out exactly as specified in TS 23.502 [8] clause 4.12a.5. The TNGF may establish one or more IPSec child SA's per PDU session.
19. User plane data for the established PDU session is transported between the UE and TNGF inside the established IPSec child SA.”

The TNGF sends the TNGF address to the UE in step 10b without any protection. The UE uses the TNGF address to later start Internet Key Exchange (IKE) process with the TNGF in step 13 of the procedure above. This is a security threat. A malicious actor can modify the address which means that the UE will connect to a wrong entity thereby causing a DoS for the UE and unnecessary resource usage.

### SUMMARY

Certain aspects of the disclosure and their embodiments may provide solutions to these or other challenges. To protect the TNGF address from illicit manipulation or access during transfer, it is protected using a key held by both the UE and the network. The TNGF address can be integrity and/or confidentiality protected using this shared key.

In one embodiment, during the UE's registration procedures to the 5G core (5GC) via a trusted non-3GPP access network (TNAN), the TNGF protects the TNGF address with TNGF key or a key derived from TNGF key and sends the TNGF address to the UE. The TNGF address is either integrity or confidentiality protected or both. When the UE receives the protected TNGF address, the UE unprotects the TNGF address, i.e., the UE verifies the integrity protection and/or decrypts the TNGF address. The UE can then use the TNGF address to perform IKE/or Internet Protocol Security (IPSec) with the TNGF.

In another embodiment, during the UE's registration procedures to the 5GC via a trusted non-3GPP access network, the TNGF sends the TNGF address to the Access and Mobility Management Function (AMF) and the AMF protects the TNGF address with a Non-Access Stratum (NAS(key (or key derived from NAS key) and sends the TNGF address to the UE (e.g., via the TNGF) in a protected NAS message (or another message). The TNGF address is confidentiality or integrity protected or both. When the UE receives the protected TNGF address, the UE unprotects the TNGF address. E.g., the UE verifies the integrity protection and/or decrypts the TNGF address. The UE can then use the TNGF address to perform IKE/IPSec with the TNGF.

To protect the TNGF address from illicit manipulation or access during transfer, it is protected using a key held by both UE and the network. The TNGF address can be integrity and/or confidentiality protected using this shared key.

In one embodiment, during the UE's registration procedures to the 5GC via a trusted non-3GPP access network, the TNGF protects the TNGF address with TNGF key or a key derived from TNGF key and sends the protected TNGF address to the UE. The TNGF address is either integrity or confidentiality protected or both. When the UE receives the protected TNGF address, the UE unprotects the TNGF address, i.e., the UE verifies the integrity protection and/or decrypts the TNGF address. The UE can then use the TNGF address to perform IKE/IPSec with the TNGF.

In another embodiment, during the UE's registration procedures to the 5GC via a trusted non-3GPP access network, the TNGF sends the TNGF address to the AMF and the AMF protects the TNGF address with a NAS key (or key derived from NAS key) and sends the protected TNGF address to the UE (e.g., via the TNGF) in a protected NAS message (or another protected message). The TNGF address is confidentiality or integrity protected or both. When the UE receives the protected TNGF address, the UE unprotects the TNGF address. E.g., the UE verifies the integrity protection and/or decrypts the TNGF address. The UE can then use the TNGF address to perform IKE/IPSec with the TNGF.

Certain embodiments may provide one or more of the following technical advantage(s).

Protecting the transport of the TNGF address helps avoid for example DoS attacks where an attacker modifies the TNGF address and therefore the UE contacts a wrong address and connection establishment fails.

There is a security and privacy trend in 3GPP that all parameters in connection establishment that can be protected should be protected. TNGF address is one of rare parameters that is still unprotected in the specifications. There is no reason why it would need to be unprotected. When security researchers find that it is unprotected, although it could and should be protected, this can create bad publicity for 3GPP systems.

In some embodiments of the disclosed subject matter, a UE performs a method for determining an address of a first network node. The method comprises receiving, from the first network node, a protected address of the first network node, wherein the protected address of the first network node is protected based on a key associated with the first network node. The method further comprises unprotecting the protected address of the first network node based on the key associated with the first network node to determine an address of the first network node, wherein unprotecting the protected address comprises at least one of (a) verifying an integrity of the address of the first network node based on the key associated with the first network node or (b) decrypting the protected address of the first network node based on the key associated with the first network node, wherein decrypting the protected address of the first network node results in the address of the first network node, and initiating a security protocol with the first network node based on the address of the first network node.

In certain related embodiments, the protected address is protected with the key associated with the first network node.

In certain related embodiments, the protected address is protected with a key derived from the key associated with the first network node.

In certain related embodiments, the UE further performs receiving, from the first network node, a first Message Authentication Code, MAC, with the protected address and wherein the verifying the address of the first network node further comprises calculating a second MAC based on the protected address of the first network node and the key associated with the first network node, and in response to the second MAC matching the first MAC, determining that the protected address of the first network node is the address of the first network node.

In certain related embodiments, the UE further performs operations comprising receiving an indication from the first network node that indicates which integrity and/or confidentiality algorithms were used to protect the TNGF address.

In certain related embodiments, the receiving the protected address of the first network node is via a TNAP associated with the first network node

In certain related embodiments, the first network node is a TNGF.

In some embodiments of the disclosed subject matter, a UE comprises processing circuitry, memory and/or transceiver circuitry that collectively perform operations as described above.

In some embodiments of the disclosed subject matter, a method is performed by a TNGF of a Trusted Non-3GPP Access Network for protecting an address of a first network node. The method comprises providing, to a user equipment device, UE, a protected address of the first network node, wherein the protected address of the first network node is protected based on a key associated with the first network node, receiving, from the UE, a request to initiate a security protocol.

In certain related embodiments, the protected address is protected with the key associated with the first network node.

In certain related embodiments, the protected address is protected with a key derived from the key associated with the first network node.

In certain related embodiments, the method further comprises providing to the UE (202) an indication that indicates which integrity and/or confidentiality algorithms were used to protect the TNGF address. In some such embodiments, in response to the indication indicating an integrity algorithm the UE should use to verify the address of the first network node. In some such embodiments, the method further comprises providing to the UE a Message Authentication Code, MAC, with the protected address, wherein the MAC is determined based on the address of the first network node and the key associated with the first network node.

In some embodiments of the disclosed subject matter, a first network node of a Trusted Non-3GPP Access Network, TNAN, for protecting an address of the first network node, comprises processing circuitry to perform operations as described above.

### BRIEF DESCRIPTION OF THE DRAWINGS

The drawings illustrate selected embodiments of the disclosed subject matter. In the drawings, like reference labels illustrate like features.

FIGS. 1A and 1B illustrate a process for Registration/Authentication and PDU Session establishment for trusted non-3GPP access.

FIG. 2 illustrates a non-roaming architecture for 5G Core Network with trusted non-3GPP access.

FIGS. 3A and 3B illustrate a message sequence chart associated with the first embodiment.

FIGS. 4A and 4B illustrate a message sequence chart associated with the second embodiment.

FIG. 5 shows an example of a communication system in accordance with some embodiments.

FIG. 6 shows a UE in accordance with some embodiments.

FIG. 7 shows a network node in accordance with some embodiments.

FIG. 8 is a block diagram of a host, which may be an embodiment of the host of FIG. 5, in accordance with various aspects described herein.

FIG. 9 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

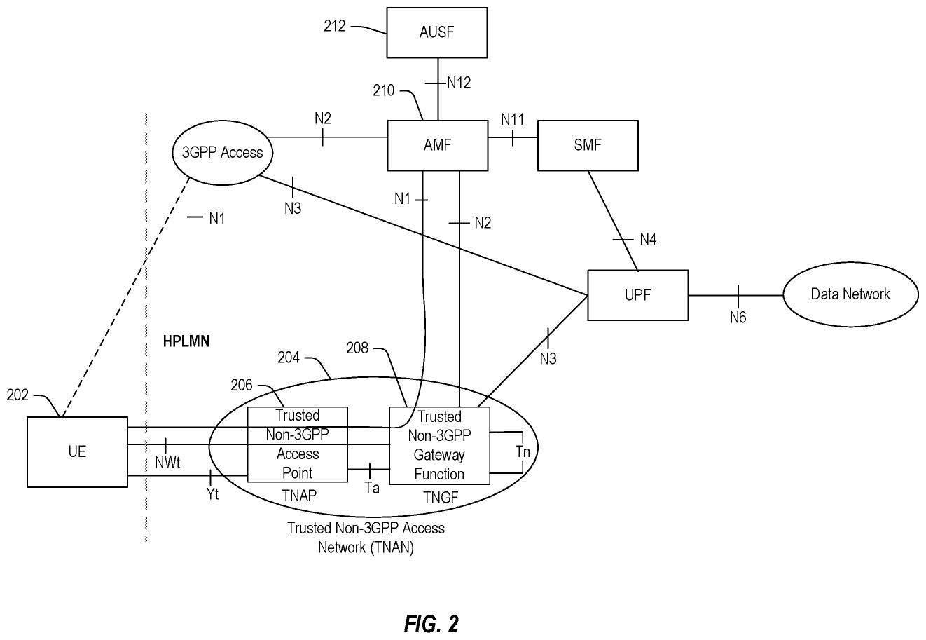

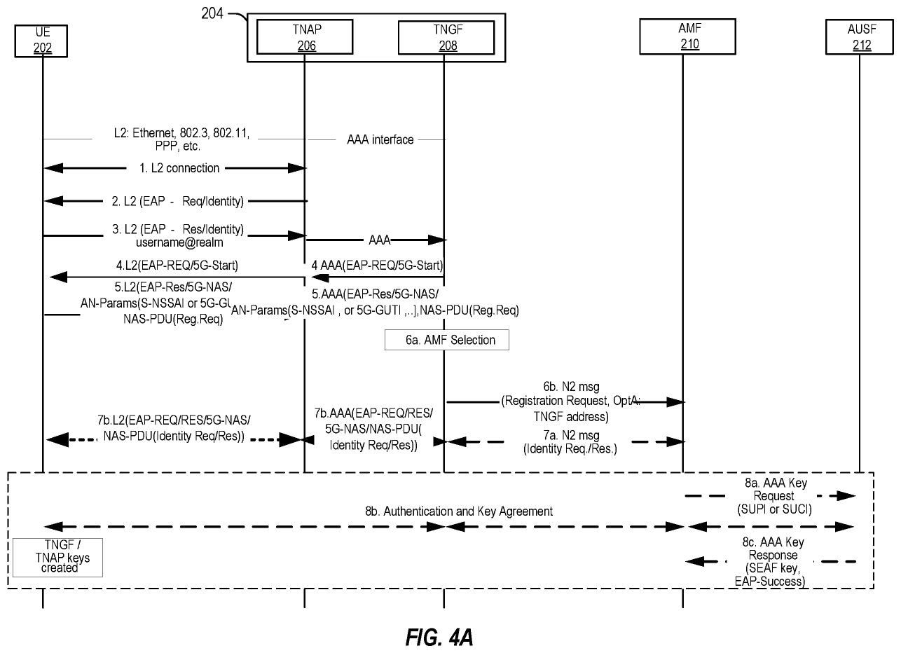

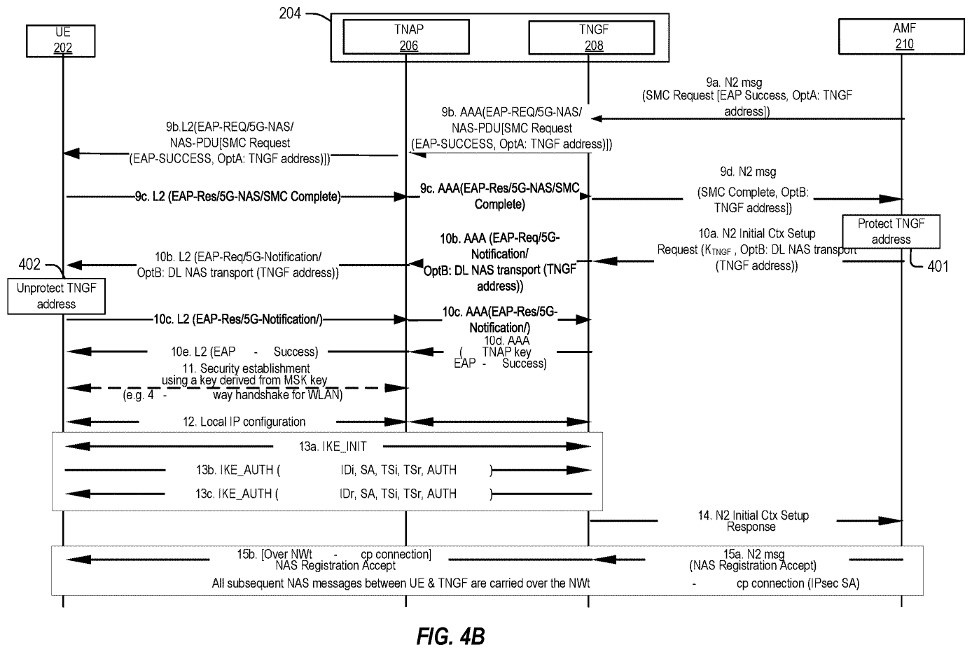

FIG. 2 corresponds to FIG. 4.2.8.2.1-2 from TS 23.501: Non-roaming architecture for 5G Core Network with trusted non-3GPP access. FIG. 2 depicts a UE 202 that can have a communication session with a 5GC via a TNAN 204 that comprises a Trusted Non-3GPP Access Point (TNAP) 206 and a TNGF 208. The TNGF 208 can also communicate with an AMF 210 and an Authentication Server Function (AUSF) 212 of the 5GC. The disclosure can provide two different embodiments for protecting the TNGF address. The first embodiments provides for protecting the TNGF address with a TNGF key. The second embodiment includes protecting the TNGF address with a NAS key.

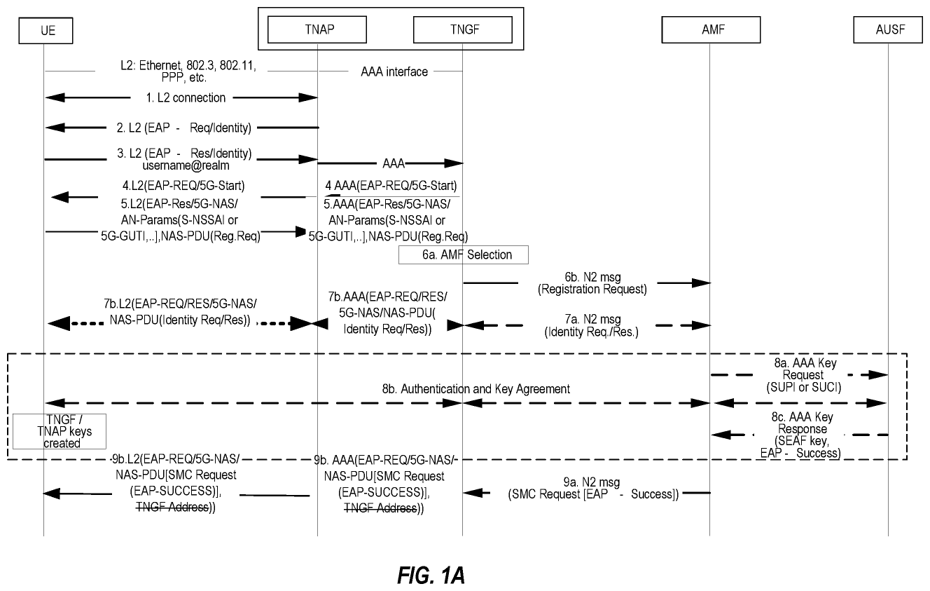

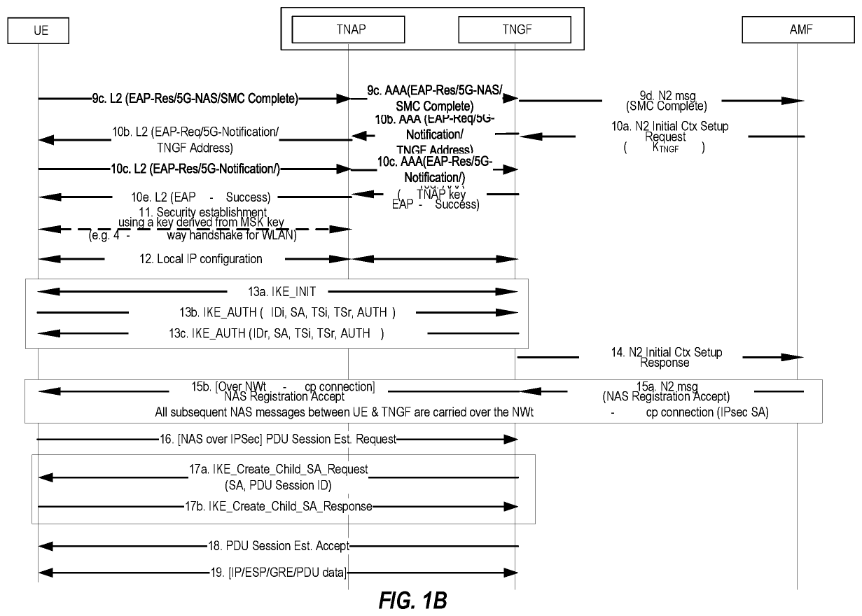

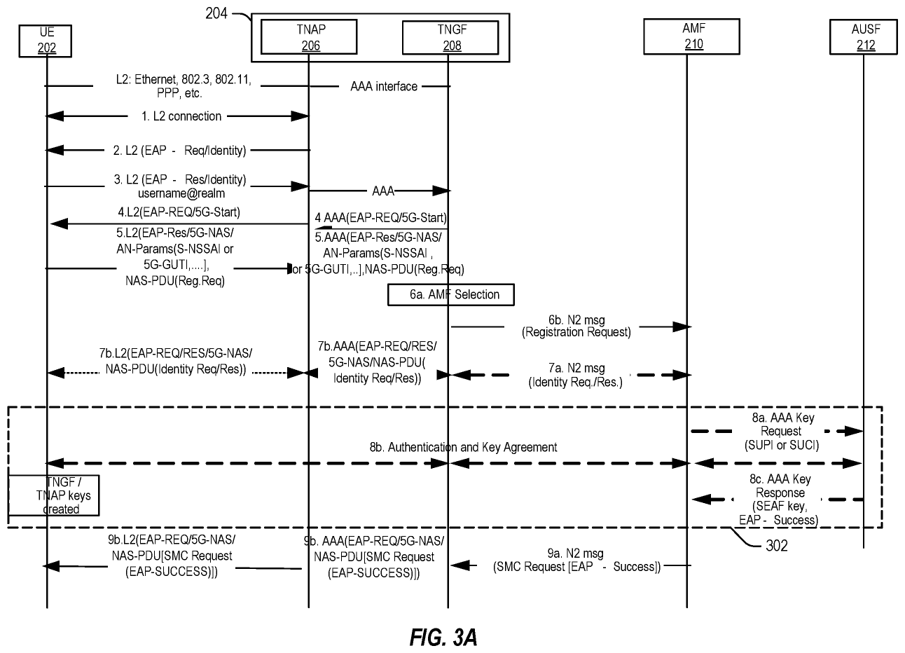

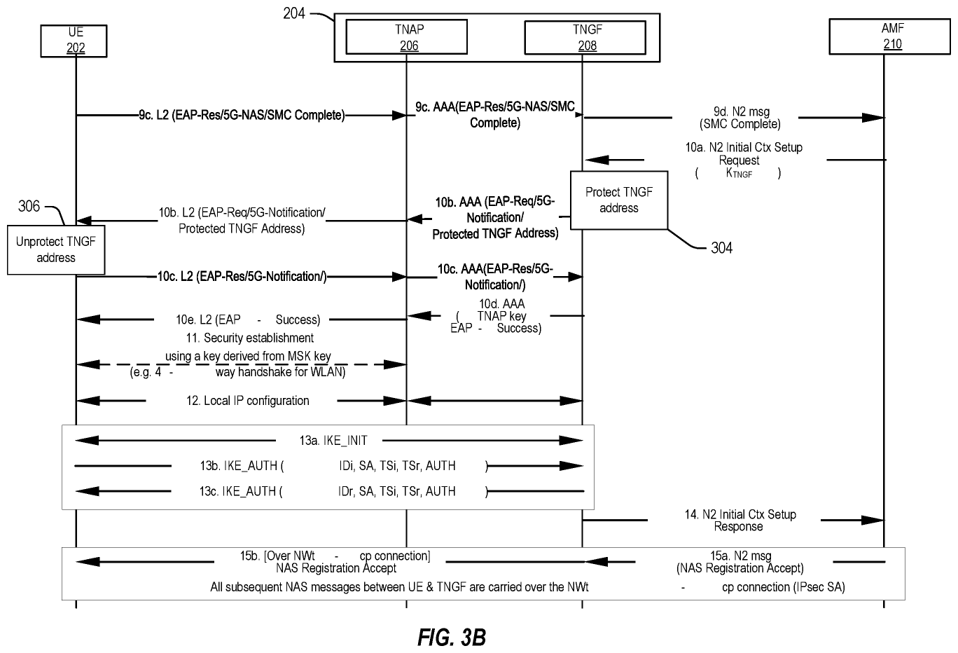

FIGS. 3A and 3B depict a message sequence chart associated with the first embodiment, and FIGS. 4A and 4B depict a message sequence chart associated with the second embodiment. Each of the message sequence charts are modifications to the message sequence chart depicted in FIGS. 1A and 1B. The underlined sequence steps described with reference to both FIGS. 3A and 3B, and FIGS. 4A and 4B in the detailed description are the new sections implemented on top of clause 7A.2.1 of TS 33.501.

In FIGS. 3A and 3B the following steps are described below:
0. The UE selects a PLMN and a TNAN for connecting to this PLMN by using the Trusted Non-3GPP Access Network selection procedure specified in TS 23.501 [2] clause 6.3.12. During this procedure, the UE discovers the PLMNs with which the TNAN supports trusted connectivity (e.g. “5G connectivity”).
1. A layer-2 connection is established between the UE and the TNAP. In case of IEEE 802.11 [80], this step corresponds to an 802.11 [80] Association. In case of PPP, this step corresponds to a PPP LCP negotiation. In other types of non-3GPP access (e.g. Ethernet), this step may not be required.
2-3. An EAP authentication procedure is initiated. EAP messages shall be encapsulated into layer-2 packets, e.g. into IEEE 802.3/802.1x packets, into IEEE 802.11/802.1x packets, into PPP packets, etc. The UE provides a NAI that triggers the TNAP to send an AAA request to a TNGF. Between the TNAP and TNGF the EAP packets are encapsulated into AAA messages.
4-10. An EAP-5G procedure is executed as specified in clause 7.2.1 with the following modifications:
   The EAP-5G packets shall not be encapsulated into IKEv2 packets. The UE shall also include a UE Id in the AN parameters, e.g. a 5G-GUTI if available from a prior registration to the same PLMN.
   A K_{TNGF} as specified in clause Annex A.9 (equivalent to K_{N3IWF}) is created in the UE and in the AMF after the successful authentication. The K_{TNGF} is transferred from the AMF to TNGF in step 10a (within the N2 Initial Context Setup Request).
   The TNAP is a trusted entity. The TNGF shall generate the K_{TNAP} as specified in Annex A.22 and transfers it from TNGF to TNAP in step 10b (within an AAA message).
   After receiving the TNGF key from AMF in step 10a, the TNGF shall send to UE an EAP-Request/5G-Notification packet containing the “TNGF Contact Info”, which includes the IP address of TNGF. Before the sending the TNGF address to the UE, the TNGF protects the TNGF address (e.g., TNGF IP address) with TNGF key or with a key derived from TNGF key [e.g., at step 304]. The TNGF address is either integrity or confidentiality protected or both. In more detail, the integrity protection can happen for example in the following way: MAC of the TNGF IP address is sent to the UE together with the address. The MAC is calculated using e.g., the IP address as input and K_{TNGF} or a key derived from the K_{TNGF}. Another example is to use authenticated encryption which provides both integrity and confidentiality protection.
   When the UE receives the protected TNGF address, the UE derives the same key which the TNGF used (this can happen also before the UE received the protected TNGF address [e.g., at step 302 when the UE can receive the TNGF key from the AMF 210 via the TNGF 208]) and unprotects [306] the TNGF address. i.e., the UE verifies the integrity protection (e.g., by verifying the MAC) and/or decrypts the TNGF address. The UE can then use the TNGF address in step 13.
   In a further additional step, the AMF may send identifiers of integrity and/or encryption algorithms (e.g., the algorithms which the UE and AMF use for NAS) to the TNGF e.g., in step 10a. The TNGF may use one or more of these algorithms to protect the TNGF address. The TNGF may also indicate to the UE in step 10b which algorithms were used to protect the TNGF address.
   After receiving an EAP-Response/5G-Notification packet from the UE, the TNGF shall send message 10b containing the EAP-Success packet.
11. The common TNAP key is used by the UE and TNAP to derive security keys according to the applied non-3GPP technology and to establish a security association to protect all subsequent traffic. In case of IEEE 802.11 [80], the K_{TNAP} is the Pairwise Master Key (PMK) and a 4-way handshake is executed (see IEEE 802.11 [80]) which establishes a security context between the WLAN AP and the UE that is used to protect unicast and multicast traffic over the air. All messages between UE and TNAP are encrypted and integrity protected from this step onwards.
NOTE 1: whether step 11 is performed out of the scope of this document. The current procedure assumes the encryption protection over Layer-2 between UE and TNAP is to be enabled.
12. The UE receives IP configuration from the TNAN, e.g. with DHCP.
13. The UE shall initiate an IKE_INIT exchange with the TNGF. The UE has received the IP address of TNGF during the EAP-5G signaling in step 10b, subsequently, the UE shall initiate an IKE_AUTH exchange and shall include the same UE Id (i.e. SUCI or 5G-GUTI) as in the UE Id provided in step 5. The common K_{TIPSec} is used for mutual authentication. The key K_{TIPSec} is derived as specified in Annex A.22. NULL encryption is negotiated as specified in RFC 2410 [81]. After step 13c, an IPsec SA is established between the UE and TNGF (i.e. a NWt connection) and it is used to transfer all subsequent NAS messages. This IPsec SA does not apply encryption but only apply integrity protection.
14. After the NWtp connection is successfully established, the TNGF responds to AMF with an N2 Initial Context Setup Response message.
15. Finally, the NAS Registration Accept message is sent by the AMF and is forwarded to UE via the established NWt connection.

FIGS. 4A and 4B describe the second embodiment where the TNGF address is protected with NAS key. In FIGS. 4A and 4B the following steps are described below:
0. The UE selects a PLMN and a TNAN for connecting to this PLMN by using the Trusted Non-3GPP Access Network selection procedure specified in TS 23.501 [2] clause 6.3.12. During this procedure, the UE discovers the PLMNs with which the TNAN supports trusted connectivity (e.g. “5G connectivity”).
1. A layer-2 connection is established between the UE and the TNAP. In case of IEEE 802.11 [80], this step corresponds to an 802.11 [80] Association. In case of PPP, this step corresponds to a PPP LCP negotiation. In other types of non-3GPP access (e.g. Ethernet), this step may not be required.
2-3. An EAP authentication procedure is initiated. EAP messages shall be encapsulated into layer-2 packets, e.g. into IEEE 802.3/802.1x packets, into IEEE 802.11/802.1x packets, into PPP packets, etc. The UE provides a NAI that triggers the TNAP to send an AAA request to a TNGF. Between the TNAP and TNGF the EAP packets are encapsulated into AAA messages.
4-10. An EAP-5G procedure is executed as specified in clause 7.2.1 with the following modifications:
   The EAP-5G packets shall not be encapsulated into IKEv2 packets. The UE shall also include a UE Id in the AN parameters, e.g. a 5G-GUTI if available from a prior registration to the same PLMN.
   A K_{TNGF} as specified in clause Annex A.9 (equivalent to K_{N3IWF}) is created in the UE and in the AMF after the successful authentication. The K_{TNGF} is transferred from the AMF to TNGF in step 10a (within the N2 Initial Context Setup Request).
   The TNAP is a trusted entity. The TNGF shall generate the K_{TNAP} as specified in Annex A.22 and transfers it from TNGF to TNAP in step 10b (within an AAA message).
   The TNGF address is transmitted and protected in the following way. The TNGF sends the TNGF address to the AMF and the AMF protects the TNGF address with a NAS key (or key derived from NAS key or with K-SEAF or a key derived from K-SEAF) and sends the protected TNGF address to the UE (e.g., via the TNGF) in a protected NAS message (or another protected message). The TNGF address is confidentiality or integrity protected or both [at step 401]. When the UE receives the protected TNGF address, the UE unprotects [step 402] the TNGF address. E.g., the UE verifies the integrity protection and/or decrypts the TNGF address. The UE can then use the TNGF address in step 13 to contact the TNGF. Example embodiments are as follows:
   Option A: the TNGF sends the TNGF address to the AMF (e.g., over a protected channel), for example in step 6b. The AMF then sends it to the UE in an integrity protected SMC request (in step 9). The UE unprotects [402] the TNGF address (e.g., as part of unprotecting the protected NAS message) and then uses the TNGF address to contact the TNGF in step 13.
   Option B: the TNGF sends the TNGF address to the AMF, for example in step 6b or 9d. The AMF then sends it to the UE in an integrity and/or confidentiality protected NAS message after the SMC procedure, e.g., in step 10 (e.g., in DL NAS transport). The UE unprotects [402] the TNGF address (e.g., as part of unprotecting the protected NAS message) and then uses the TNGF address to contact the TNGF in step 13.
   Option C (not shown in figure): the TNGF sends the TNGF address to the AMF, for example in step 6b or 9d. The AMF calculates [step 401] a MAC for integrity protection of the TNGF address using the NAS integrity key (or a key derived from K-SEAF) and NAS DL count. The AMF sends the MAC, DL count (or some part of DL count) and optionally the TNGF address to the TNGF. The TNGF sends the MAC, DL count (or some part of DL count) and TNGF address to the UE. e.g., in step 10. The UE will locate the NAS security context and verifies the MAC. The UE then uses the TNGF address to contact the TNGF in step 13.
   After receiving an EAP-Response/5G-Notification packet from the UE, the TNGF shall send message 10b containing the EAP-Success packet.
11. The common TNAP key is used by the UE and TNAP to derive security keys according to the applied non-3GPP technology and to establish a security association to protect all subsequent traffic. In case of IEEE 802.11 [80], the K_{TNAP} is the Pairwise Master Key (PMK) and a 4-way handshake is executed (see IEEE 802.11 [80]) which establishes a security context between the WLAN AP and the UE that is used to protect unicast and multicast traffic over the air. All messages between UE and TNAP are encrypted and integrity protected from this step onwards.
NOTE 1: whether step 11 is performed out of the scope of this document. The current procedure assumes the encryption protection over Layer-2 between UE and TNAP is to be enabled.
12. The UE receives IP configuration from the TNAN, e.g. with DHCP.
13. The UE shall initiate an IKE_INIT exchange with the TNGF. The UE has received the IP address of TNGF during the EAP-5G signaling in step 9b or step 10b, subsequently, the UE shall initiate an IKE_AUTH exchange and shall include the same UE Id (i.e. SUCI or 5G-GUTI) as in the UE Id provided in step 5. The common K_{TIPSec} is used for mutual authentication. The key K_{TIPSec} is derived as specified in Annex A.22. NULL encryption is negotiated as specified in RFC 2410 [81]. After step 13c, an IPsec SA is established between the UE and TNGF (i.e. a NWt connection) and it is used to transfer all subsequent NAS messages. This IPsec SA does not apply encryption but only apply integrity protection.
14. After the NWtp connection is successfully established, the TNGF responds to AMF with an N2 Initial Context Setup Response message.
15. Finally, the NAS Registration Accept message is sent by the AMF and is forwarded to UE via the established NWt connection.

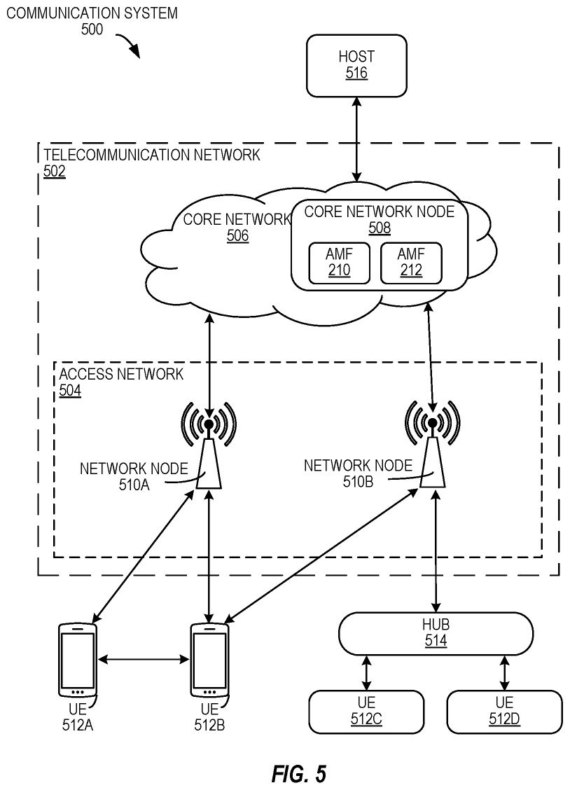

FIG. 5 shows an example of a communication system 500 in accordance with some embodiments.

In the example, the communication system 500 includes a telecommunication network 502 that includes an access network 504, such as a Radio Access Network (RAN), and a core network 506, which includes one or more core network nodes 508. The access network 504 includes one or more access network nodes, such as network nodes 510A and 510B (one or more of which may be generally referred to as network nodes 510), or any other similar Third Generation Partnership Project (3GPP) access node or non-3GPP Access Point (AP). The network nodes 510 facilitate direct or indirect connection of User Equipment (UE), such as by connecting UEs 512A, 512B, 512C, and 512D (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), AMF 210, Session Management Function (SMF), AUSF 212, Subscription Identifier De-Concealing Function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system 500 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 502 is a cellular network that implements 3GPP standardized features. Accordingly, the telecommunication network 502 may support network slicing to provide different logical networks to different devices that are connected to the telecommunication network 502. For example, the telecommunication network 502 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 514 communicates with the access network 504 to facilitate indirect communication between one or more UEs (e.g., UE 512C and/or 512D) and network nodes (e.g., network node 510B). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a Virtual Reality (VR) headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510B. The hub 514 may also allow for a different communication scheme and/or schedule between the hub 514 and UEs (e.g., UE 512C and/or 512D), and between the hub 514 and the core network 506. In other examples, the hub 514 is connected to the core network 506 and/or one or more UEs via a wired connection. Moreover, the hub 514 may be configured to connect to a Machine-to-Machine (M2M) service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub-that is, a hub whose primary function is to route communications to/from the UEs from/to the network node 510B. In other embodiments, the hub 514 may be a non-dedicated hub-that is, a device which is capable of operating to route communications between the UEs and the network node 510B, but which is additionally capable of operating as a communication start and/or end point for certain data channels.

FIG. 6 shows a UE 600 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 602 may include multiple Central Processing Units (CPUs).

In the example, the input/output interface 606 may be configured to provide an interface or interfaces to an input device, output device, or one or more input and/or output devices.

Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack.

Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging the power source 608. Power circuitry may perform any formatting, converting, or other modification to the power from the power source 608 to make the power suitable for the respective components of the UE 600 to which power is supplied.

The memory 610 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 610 may allow the UE 600 to access instructions, application programs, and the like stored on transitory or non-transitory memory media, to off-load data, or to upload data. An article of manufacture, such as one utilizing a communication system, may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., the antenna 622) and may share circuit components, software, or firmware, or alternatively be implemented separately.

In the illustrated embodiment, communication functions of the communication interface 612 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 612, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case.

For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

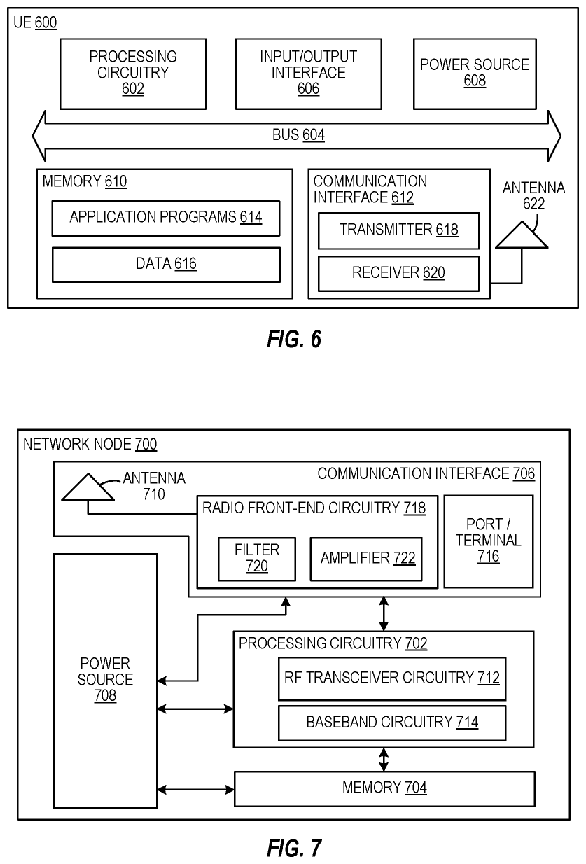

FIG. 7 shows a network node 700 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes processing circuitry 702, memory 704, a communication interface 706, and a power source 708. The network node 700 may be composed of multiple physically separate components (e.g., a Node B component and an RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 700 may be configured to support multiple RATs. In such embodiments, some components may be duplicated (e.g., separate memory 704 for different RATs) and some components may be reused (e.g., an antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 700.

The processing circuitry 702 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 700 components, such as the memory 704, to provide network node 700 functionality.

In some embodiments, the processing circuitry 702 includes a System on a Chip (SOC). In some embodiments, the processing circuitry 702 includes one or more of Radio Frequency (RF) transceiver circuitry 712 and baseband processing circuitry 714. In some embodiments, the RF transceiver circuitry 712 and the baseband processing circuitry 714 may be on separate chips (or sets of chips), boards, or units, such as radio units and digital units. In alternative embodiments, part or all of the RF transceiver circuitry 712 and the baseband processing circuitry 714 may be on the same chip or set of chips, boards, or units.

The memory 704 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and the memory 704 are integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. The radio front-end circuitry 718 comprises filters 720 and amplifiers 722. The radio front-end circuitry 718 may be connected to the antenna 710 and the processing circuitry 702. The radio front-end circuitry 718 may be configured to condition signals communicated between the antenna 710 and the processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of the filters 720 and/or the amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface 706 may comprise different components and/or different combinations of components.

In certain alternative embodiments, the network node 700 does not include separate radio front-end circuitry 718; instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes the one or more ports or terminals 716, the radio front-end circuitry 718, and the RF transceiver circuitry 712 as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, the communication interface 706, and/or the processing circuitry 702 may be configured to perform any receiving operations and/or certain obtaining operations described herein as being performed by the network node 700. Any information, data, and/or signals may be received from a UE, another network node, and/or any other network equipment. Similarly, the antenna 710, the communication interface 706, and/or the processing circuitry 702 may be configured to perform any transmitting operations described herein as being performed by the network node 700. Any information, data, and/or signals may be transmitted to a UE, another network node, and/or any other network equipment.

The power source 708 provides power to the various components of the network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid or an electricity outlet) via input circuitry or an interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

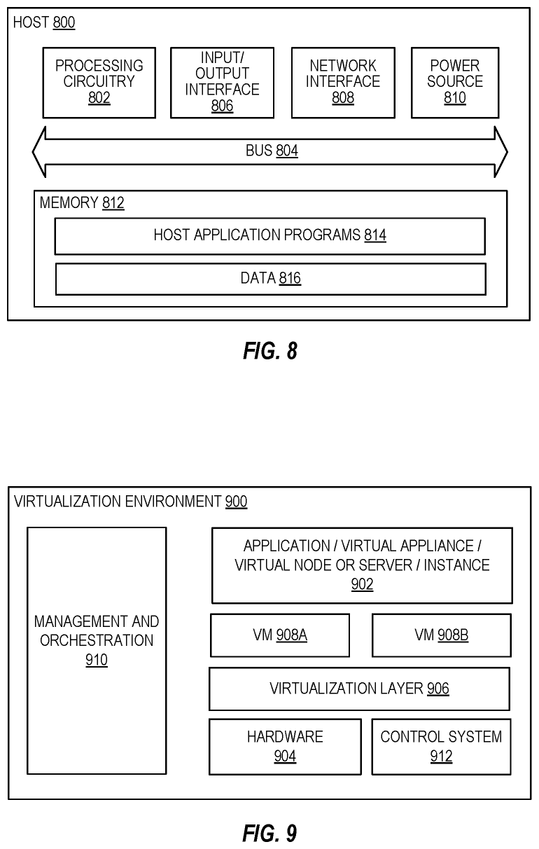

FIG. 8 is a block diagram of a host 800, which may be an embodiment of the host 516 of FIG. 5, in accordance with various aspects described herein. As used herein, the host 800 may be or comprise various combinations of hardware and/or software including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and memory 812. Other components may be included in other embodiments. Features of these components may be substantially similar to those described with respect to the devices of previous figures, such as FIGS. 6 and 7, such that the descriptions thereof are generally applicable to the corresponding components of the host 800.

The memory 812 may include one or more computer programs including one or more host application programs 814 and data 816, which may include user data, e.g. data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 814 may also provide for user authentication and licensing checks and may periodically report health, routes, and content availability to a central node, such as a device in or on the edge of a core network. Accordingly, the host 800 may select and/or indicate a different host for Over-The-Top (OTT) services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or VM Monitors (VMMs)), provide VMs 908A and 908B (one or more of which may be generally referred to as VMs 908), and/or perform any of the functions, features, and/or benefits described in relation with some embodiments described herein. The virtualization layer 906 may present a virtual operating platform that appears like networking hardware to the VMs 908.

The VMs 908 comprise virtual processing, virtual memory, virtual networking, or interface and virtual storage, and may be run by a corresponding virtualization layer 906.

Different embodiments of the instance of a virtual appliance 902 may be implemented on one or more of the VMs 908, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 908 may be a software implementation of a physical machine that runs programs as if they were executing on a physical, non-virtualized machine.

Each of the VMs 908, and that part of the hardware 904 that executes that VM, be it hardware dedicated to that VM and/or hardware shared by that VM with others of the VMs 908, forms separate virtual network elements. Still in the context of NFV, a virtual network function is responsible for handling specific network functions that run in one or more VMs 908 on top of the hardware 904 and corresponds to the application 902.

The hardware 904 may be implemented in a standalone network node with generic or specific components. The hardware 904 may implement some functions via virtualization.

Alternatively, the hardware 904 may be part of a larger cluster of hardware (e.g., such as in a data center or CPE) where many hardware nodes work together and are managed via management and orchestration 910, which, among others, oversees lifecycle management of the applications 902. In some embodiments, the hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 912 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

1. A method performed by a user equipment device, UE, for determining an address of a first network node the method comprising:
receiving from the first network node, a protected address of the first network node, wherein the protected address of the first network node is protected based on a key associated with the first network node;
unprotecting the protected address of the first network node based on the key associated with the first network node to determine an address of the first network node, wherein unprotecting the protected address comprises at least one of:
verifying an integrity of the address of the first network node based on the key associated with the first network node; or
decrypting the protected address of the first network node based on the key associated with the first network node, wherein decrypting the protected address of the first network node results in the address of the first network node; and
initiating a security protocol with the first network node based on the address of the first network node.

2. The method of claim 1, wherein the protected address is protected with the key associated with the first network node.

3. The method of claim 1, wherein the protected address is protected with a key derived from the key associated with the first network node.

4. The method of claim 1, further comprising:
receiving, from the first network node, a first Message Authentication Code, MAC, with the protected address and wherein the verifying the address of the first network node further comprises:
calculating a second MAC based on the protected address of the first network node and the key associated with the first network node; and
in response to the second MAC matching the first MAC, determining that the protected address of the first network node is the address of the first network node.

5. The method of claim 1, further comprising:
receiving an indication from the first network node that indicates which integrity and/or confidentiality algorithms were used to protect the address of the first network node.

6. The method of claim 1, wherein the receiving the protected address of the first network node is via a Trusted Non-3GPP Access Point, TNAP, associated with the first network node.

7. (canceled)

8. A user equipment device, UE, that determines an address of a first network node the UE comprising processing circuitry to perform operations, the operations comprising:
receiving from the first network node, a protected address of the first network node, wherein the protected address of the first network node is protected based on a key associated with the first network node;
unprotecting the protected address of the first network node based on the key associated with the first network node to determine an address of the TNGG, wherein unprotecting the protected address comprises at least one of:
verifying an integrity of the address of the first network node based on the key associated with the first network node; or
decrypting the protected address of the first network node based on the key associated with the first network node, wherein decrypting the protected address of the first network node results in the address of the first network node; and
initiating a security protocol with the first network node based on the address of the first network node

9. (canceled)

10. A method performed by a first network node, for protecting an address of a first network node the method comprising:
providing, to a user equipment device, UE, a protected address of the first network node, wherein the protected address of the first network node is protected based on a key associated with the UE; and
receiving, from the UE, a request to initiate a security protocol.

11. The method of claim 10, wherein the protected address is protected with the key associated with the UE.

12. The method of claim 10, wherein the protected address is protected with a key derived from the key associated with the UE.

13. The method of claim 10, further comprising:
providing to the UE an indication that indicates which integrity and/or confidentiality algorithms were used to protect the address of the first network node.

14. The method of claim 13, wherein in response to the indication indicating an integrity algorithm the UE should use to verify the address of the first network node, the method further comprises:
providing to the UE a Message Authentication Code, MAC, with the protected address, wherein the MAC is determined based on the address of the first network node and the key associated with the first network node.

15. A first network node of a Trusted Non-3GPP Access Network, TNAN, for protecting an address of the first network node, comprising processing circuitry to perform operations, the operations comprising:
providing, to a User Equipment device, UE, a protected address of the first network node, wherein the protected address of the first network node is protected based on a key associated with the first network node and
receiving, from the UE, a request to initiate a security protocol.

16-35. (canceled)

36. The UE of claim 8, wherein the protected address is protected with the key associated with the first network node.

37. The UE of claim 8, wherein the protected address is protected with a key derived from the key associated with the first network node.

38. The UE of claim 8, wherein the processing circuitry is further configured to receive, from the first network node, a first Message Authentication Code, MAC, with the protected address and wherein the verifying the address of the first network node further comprises:
calculating a second MAC based on the protected address of the first network node and the key associated with the first network node; and
in response to the second MAC matching the first MAC, determining that the protected address of the first network node is the address of the first network node.

39. The UE of claim 8, wherein the processing circuitry is further configured to receive an indication from the first network node that indicates which integrity and/or confidentiality algorithms were used to protect the address of the first network node.

40. The UE of claim 8, wherein the receiving the protected address of the first network node is via a Trusted Non-3GPP Access Point, TNAP, associated with the first network node.

41. The first network node of claim 15, wherein the protected address is protected with the key associated with the UE.

42. The first network node of claim 15, wherein the protected address is protected with a key derived from the key associated with the UE.

43. The first network node of claim 15, wherein the processing circuitry is further configured to provide to the UE an indication that indicates which integrity and/or confidentiality algorithms were used to protect the address of the first network node.

44. The first network node of claim 43, wherein in response to the indication indicating an integrity algorithm the UE should use to verify the address of the first network node, the method further comprises:
providing to the UE a Message Authentication Code, MAC, with the protected address, wherein the MAC is determined based on the address of the first network node and the key associated with the first network node.
